(19) United States
(12) Patent Application Publication
(10) Pub. No.: US 2022/0345357 A1
(43) Pub. Date: Oct. 27, 2022

(54) IN-VEHICLE COMMUNICATION SYSTEM, IN-VEHICLE DEVICE, AND VEHICLE COMMUNICATION METHOD

(71) Applicants: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(72) Inventors: Akihito IWATA, Osaka-shi (JP); Takeshi HAGIHARA, Yokkaichi-shi (JP); Darmawan GO, Yokkaichi-shi (JP); Yosuke SHIMIZU, Yokkaichi-shi (JP)

(73) Assignees: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(21) Appl. No.: 17/616,891

(22) PCT Filed: May 7, 2020
(86) PCT No.: PCT/JP2020/018515

§ 371 Date: Dec. 6, 2021

(30) Foreign Application Priority Data
Jul. 9, 2019 (JP) 2019-127304

(51) Int. Cl. H04L 41/0654; H04L 12/40; H04L 12/44

(52) U.S. Cl. CPC H04L 41/0654; H04L 12/40; H04L 12/44; H04L 2012/40215; H04L 2012/40273

(57) ABSTRACT

An in-vehicle communication system includes a plurality of in-vehicle devices each being connected to an Ethernet network and a CAN (Controller Area Network). Each of the plurality of in-vehicle devices transmits and receives information to and from another in-vehicle device via the Ethernet network and the CAN. At least one of the plurality of in-vehicle devices is able to transmit the same information to the Ethernet network and the CAN in parallel.

### TECHNICAL FIELD

The present invention relates to an in-vehicle communication system, an in-vehicle device, and a vehicle communication method.

This application claims priority on Japanese Patent Application No. 2019-127304 filed on Jul. 9, 2019, the entire content of which is incorporated herein by reference.

### BACKGROUND ART

PATENT LITERATURE 1 (Japanese Laid-Open Patent Publication No. 2011-205444) discloses a network system as follows. That is, the network system includes a plurality of nodes, and a topology thereof is constructed in advance. Each node includes: a topology information table having information necessary for construction of the topology; a topology association table in which a topology ID that is identification information according to a failure is associated with the topology information table; a topology change detection unit that detects a failure when receiving a frame from another node; a topology selection unit that selects the topology ID according to the failure; and a frame transmission/reception unit that transmits, to an adjacent node, a frame in which the topology ID selected by the topology selection unit is stored. Upon receiving the topology ID from the frame transmission/reception unit, the topology change detection unit of the adjacent node performs setting change thereof with reference to the topology information table corresponding to the topology ID.

### CITATION LIST

### Patent Literature

PATENT LITERATURE 1: Japanese Laid-Open Patent Publication No. 2011-205444

### SUMMARY OF INVENTION

An in-vehicle communication system according to the present disclosure includes a plurality of in-vehicle devices each being connected to an Ethernet network and a CAN (Controller Area Network). Each of the plurality of in-vehicle devices transmits and receives information to and from another in-vehicle device via the Ethernet network and the CAN. At least one of the plurality of in-vehicle devices is able to transmit the same information to the Ethernet network and the CAN in parallel.

An in-vehicle communication system according to the present disclosure includes a plurality of in-vehicle devices each being connected to a first network and a second network. Each of the plurality of in-vehicle devices transmits and receives information to and from another in-vehicle device via the first network and the second network. At least one of the plurality of in-vehicle devices is able to transmit the same information, out of information to be transmitted to the first network, related to control of a vehicle or in-vehicle equipment to the first network and the second network in parallel.

An in-vehicle device according to the present disclosure is connected to an

Ethernet network and a CAN, and includes: a processing unit configured to generate information to be transmitted to another in-vehicle device; a first communication unit configured to transmit the information generated by the processing unit to the other in-vehicle device via the Ethernet network; and a second communication unit configured to transmit the information generated by the processing unit to the other in-vehicle device via the CAN. The first communication unit and the second communication unit are able to transmit the same information in parallel.

An in-vehicle device according to the present disclosure is connected to an Ethernet network and a CAN, and includes: a first communication unit configured to receive information from the Ethernet network; a second communication unit configured to receive information from the CAN; and a processing unit capable of performing a process using the information received by the first communication unit, and a process using the information received by the second communication unit. When the information received by the first communication unit overlaps the information received by the second communication unit, the processing unit discards one of the information received by the first communication unit and the information received by the second communication unit.

An in-vehicle device according to the present disclosure is connected to a first network and a second network, and includes: a processing unit configured to generate information to be transmitted to another in-vehicle device; a first communication unit configured to transmit the information generated by the processing unit to the other in-vehicle device via the first network; and a second communication unit configured to transmit the information generated by the processing unit to the other in-vehicle device via the second network. The first communication unit and the second communication unit are able to transmit the same information, in parallel, which is related to control of a vehicle or in-vehicle equipment and is generated by the processing unit.

An in-vehicle device according to the present disclosure is connected to a first network and a second network, and includes: a first communication unit configured to receive information from the first network; a second communication unit configured to receive information from the second network; and a processing unit capable of performing a process using the information received by the first communication unit, and a process using the information received by the second communication unit. When control information that is related to control of a vehicle or in-vehicle equipment and is received by the first communication unit overlaps the control information that is related to control of the vehicle or the in-vehicle equipment and is received by the second communication unit, the processing unit discards one of the control information received by the first communication unit and the control information received by the second communication unit.

A vehicle communication method according to the present disclosure is a method used in an in-vehicle communication system including a plurality of in-vehicle devices each being connected to an Ethernet network and a CAN. Each of the in-vehicle devices transmits and receives information to and from another in-vehicle device via the Ethernet network and the CAN. The method includes: a step in which the in-vehicle device detects an abnormality in the Ethernet network; and a step in which the in-vehicle device having detected the abnormality switches transmission of information via the Ethernet network to transmission of the information via the CAN.

A vehicle communication method according to the present disclosure is a method used in an in-vehicle communication system including a plurality of in-vehicle devices each being connected to an Ethernet network and a CAN. Each of the in-vehicle devices transmits and receives information to and from another in-vehicle device via the Ethernet network and the CAN. The method includes: a step in which the in-vehicle device transmits the same information to both the Ethernet network and the CAN; and a step in which the other in-vehicle device detects an overlap between the information received from the Ethernet network and the information received from the CAN, and discards one of the information received from the Ethernet network and the information received from the CAN.

A vehicle communication method according to the present disclosure is a method used in an in-vehicle communication system including a plurality of in-vehicle devices each being connected to a first network and a second network. Each of the in-vehicle devices transmits and receives information to and from another in-vehicle device via the first network and the second network. The method includes: a step in which the in-vehicle device transmits the same control information related to control of a vehicle or in-vehicle equipment to both the first network and the second network; and a step in which the other in-vehicle device detects an overlap between the control information received from the first network and the control information received from the second network, and discards one of the control information received from the first network and the control information received from the second network.

An aspect of the present disclosure can be realized as a semiconductor integrated circuit that realizes a part of or the entire in-vehicle communication system. An aspect of the present disclosure can be realized as a semiconductor integrated circuit that realizes a part of or the entire in-vehicle device.

An aspect of the present disclosure can be realized as an in-vehicle device that includes such a characteristic processing unit, and can also be realized as a method that includes such characteristic processes as steps.

An aspect of the present disclosure can be realized as a program for causing a computer to execute the process steps in the in-vehicle communication system. An aspect of the present disclosure can be realized as a program for causing a computer to execute the process steps in the in-vehicle device.

### BRIEF DESCRIPTION OF DRAWINGS

FIG. 1 shows a configuration of an in-vehicle communication system according to an embodiment of the present disclosure.

FIG. 2 shows a specific configuration of the in-vehicle communication system according to the embodiment of the present disclosure.

FIG. 3 shows a configuration of an in-vehicle device according to the embodiment of the present disclosure.

FIG. 4 shows an example of an Ethernet frame generated by a processing unit of the in-vehicle device according to the embodiment of the present disclosure.

FIG. 5 shows an example of a CAN frame generated by the processing unit of the in-vehicle device according to the embodiment of the present disclosure.

FIG. 6 is a flowchart of an example of an operation procedure when an in-vehicle device transmits information to another in-vehicle device in the in-vehicle communication system according to the embodiment of the present disclosure.

FIG. 7 is a flowchart of another example of an operation procedure when an in-vehicle device transmits information to another in-vehicle device in the in-vehicle communication system according to the embodiment of the present disclosure.

FIG. 8 shows an example of a sequence of processing when an in-vehicle device transmits information to another in-vehicle device in the in-vehicle communication system according to the embodiment of the present disclosure.

FIG. 9 shows another example of a sequence of processing when an in-vehicle device transmits information to another in-vehicle device in the in-vehicle communication system according to the embodiment of the present disclosure.

### DESCRIPTION OF EMBODIMENTS

To date, a technology of reconstructing a topology when a failure occurs in an in-vehicle network has been developed.

### Problems to be Solved by the Present Disclosure

Beyond the technology described in PATENT LITERATURE 1, a technology capable of realizing stable communication on an in-vehicle network has been desired.

The present disclosure is made to solve the above problem and it is an object of the present disclosure to provide an in-vehicle communication system, an in-vehicle device, and a vehicle communication method which are capable of realizing stable communication on an in-vehicle network.

### Effects of the Present Disclosure

According to the present disclosure, stable communication on an in-vehicle network can be realized.

### Description of Embodiment of the Present Disclosure

First, contents of embodiments of the present disclosure are listed and described.

(1) An in-vehicle communication system according to the embodiment of the present disclosure includes a plurality of in-vehicle devices each being connected to an Ethernet network and a CAN. Each of the plurality of in-vehicle devices transmits and receives information to and from another in-vehicle device via the Ethernet network and the CAN. At least one of the plurality of in-vehicle devices is able to transmit the same information to the Ethernet network and the CAN in parallel.

As described above, since the same information can be transmitted to the Ethernet network and the CAN in parallel, even when an abnormality occurs in one of the Ethernet network and the CAN, the information to be transmitted to the other in-vehicle device via this network can be transmitted via the other network. Thus, it is possible to realize stable communication in the in-vehicle network.

(2) Preferably, when the in-vehicle device has detected an abnormality in the Ethernet network, the in-vehicle device switches a part or an entirety of transmission of information via the Ethernet network, to transmission of the information via the CAN.

With this configuration, even when an abnormality occurs in the Ethernet network, it is possible to transmit the information via the CAN which has a higher resistance to noise that may occur in the in-vehicle network than the Ethernet network and which can construct a redundant path by using simple wiring.

(3) Preferably, the in-vehicle device transmits the same information to both the Ethernet network and the CAN, and when the information received from the Ethernet network overlaps the information received from the CAN, the other in-vehicle device discards one of the information received from the Ethernet network and the information received from the CAN.

With this configuration, it is possible to prevent the reception-side in-vehicle device from performing duplicate processing on the information, while increasing the resistance to noise or the like by transmitting the same information to the respective networks.

(4) More preferably, the in-vehicle device on a transmission side assigns the same sequence number to the pieces of information to be transmitted to the Ethernet network and the CAN in parallel, and transmits the pieces of information, and the in-vehicle device on a reception side detects an overlap of the pieces of information by using the sequence number included in the received information.

With this configuration, the reception-side in-vehicle device can easily and reliably detect an overlap of the pieces of information received from both the networks.

(5) Preferably, the in-vehicle device selectively transmits a part of the information to be transmitted to the Ethernet network, to the Ethernet network and the CAN in parallel.

With this configuration, for example, a part, having a higher priority, out of the information to be transmitted to the Ethernet network can be reliably transmitted to the reception-side in-vehicle device, while inhibiting an increase in communication traffic in the in-vehicle network.

(6) More preferably, the in-vehicle device transmits information related to control of a vehicle or in-vehicle equipment, out of the information to be transmitted to the Ethernet network, to the Ethernet network and the CAN in parallel.

With this configuration, the information related to control of the vehicle or the in-vehicle equipment, which is highly important information, can be reliably transmitted to the reception-side in-vehicle device.

(7) Preferably, the in-vehicle device transmits information not to be transmitted via the Ethernet network and the CAN, out of the information related to control of the vehicle or the in-vehicle equipment, to the other in-vehicle device via a dedicated line.

With this configuration, for example, information, whose allowable delay time is relatively short and which has a higher priority, can be reliably transmitted to the reception-side in-vehicle device, with a reduced delay time, while stably transmitting other information by using the Ethernet network and the CAN.

(8) An in-vehicle communication system according to the embodiment of the present disclosure includes a plurality of in-vehicle devices each being connected to a first network and a second network. Each of the plurality of in-vehicle devices transmits and receives information to and from another in-vehicle device via the first network and the second network. At least one of the plurality of in-vehicle devices is able to transmit the same information related to control of a vehicle or in-vehicle equipment to the first network and the second network in parallel.

As described above, since the same information related to control of the vehicle or the in-vehicle equipment can be transmitted to the first network and the second network in parallel, even when an abnormality occurs in one of the first network and the second network, the highly important information to be transmitted via this network can be transmitted via the other network. Therefore, it is possible to realize stable communication in the in-vehicle network.

(9) An in-vehicle device according to the embodiment of the present disclosure is connected to an Ethernet network and a CAN, and includes: a processing unit configured to generate information to be transmitted to another in-vehicle device; a first communication unit configured to transmit the information generated by the processing unit to the other in-vehicle device via the Ethernet network; and a second communication unit configured to transmit the information generated by the processing unit to the other in-vehicle device via the CAN. The first communication unit and the second communication unit are able to transmit the same information in parallel.

As described above, since the same information can be transmitted to the Ethernet network and the CAN in parallel, even when an abnormality occurs in one of the Ethernet network and the CAN, the information to be transmitted to the other in-vehicle device via this network can be transmitted via the other network. Thus, it is possible to realize stable communication in the in-vehicle network.

(10) An in-vehicle device according to the embodiment of the present disclosure is connected to an Ethernet network and a CAN, and includes: a first communication unit configured to receive information from the Ethernet network; a second communication unit configured to receive information from the CAN; and a processing unit capable of performing a process using the information received by the first communication unit, and a process using the information received by the second communication unit. When the information received by the first communication unit overlaps the information received by the second communication unit, the processing unit discards one of the information received by the first communication unit and the information received by the second communication unit.

With this configuration, even when an abnormality occurs in one of the Ethernet network and the CAN, the information can be received from the other network. Moreover, when the same information is received from the two networks in an overlapping manner, it is possible to avoid duplicate processing on the information. Thus, it is possible to realize stable communication in the in-vehicle network.

(11) An in-vehicle device according to the embodiment of the present disclosure is connected to a first network and a second network, and includes: a processing unit configured to generate information to be transmitted to another in-vehicle device; a first communication unit configured to transmit the information generated by the processing unit to the other in-vehicle device via the first network; and a second communication unit configured to transmit the information generated by the processing unit to the other in-vehicle device via the second network. The first communication unit and the second communication unit are able to transmit the same information, in parallel, which is related to control of a vehicle or in-vehicle equipment and is generated by the processing unit.

Since the same information related to control of the vehicle or the in-vehicle equipment can be transmitted to the first network and the second network in parallel, even when an abnormality occurs in one of the first network and the second network, the highly important information to be transmitted to the other in-vehicle device via this network can be transmitted via the other network. Thus, it is possible to realize stable communication in the in-vehicle network.

(12) An in-vehicle device according to the embodiment of the present disclosure is connected to a first network and a second network, and includes: a first communication unit configured to receive information from the first network; a second communication unit configured to receive information from the second network; and a processing unit capable of performing a process using the information received by the first communication unit, and a process using the information received by the second communication unit. When control information that is related to control of a vehicle or in-vehicle equipment and is received by the first communication unit overlaps the control information that is related to control of the vehicle or the in-vehicle equipment and is received by the second communication unit, the processing unit discards one of the control information received by the first communication unit and the control information received by the second communication unit.

With this configuration, even when an abnormality occurs in one of the first network and the second network, the highly important information related to control of the vehicle or the in-vehicle equipment can be received from the other network. Moreover, when the same information is received from the two networks in an overlapping manner, it is possible to avoid duplicate processing on the information. Thus, it is possible to realize stable communication in the in-vehicle network.

(13) A vehicle communication method according to the embodiment of the present disclosure is a method used in an in-vehicle communication system including a plurality of in-vehicle devices each being connected to an Ethernet network and a CAN. Each of the in-vehicle devices transmits and receives information to and from another in-vehicle device via the Ethernet network and the CAN. The method includes: a step in which the in-vehicle device detects an abnormality in the Ethernet network; and a step in which the in-vehicle device having detected the abnormality switches transmission of information via the Ethernet network to transmission of the information via the CAN.

In this method, even when an abnormality occurs in the Ethernet network, it is possible to transmit the information via the CAN which has a higher resistance to noise that may occur in the in-vehicle network than the Ethernet network and which can construct a redundant path by using simple wiring. Thus, it is possible to realize stable communication in the in-vehicle network.

(14) A vehicle communication method according to the embodiment of the present disclosure is a method used in an in-vehicle communication system including a plurality of in-vehicle devices each being connected to an Ethernet network and a CAN. Each of the in-vehicle devices transmits and receives information to and from another in-vehicle device via the Ethernet network and the CAN. The method includes: a step in which the in-vehicle device transmits the same information to both the Ethernet network and the CAN; and a step in which the other in-vehicle device detects an overlap between the information received from the Ethernet network and the information received from the CAN, and discards one of the information received from the Ethernet network and the information received from the CAN.

In this method, even when an abnormality occurs in one of the Ethernet network and the CAN, the information can be transmitted and received via the other network. Moreover, the reception-side in-vehicle device is prevented from performing duplicate processing on the same information. Thus, it is possible to realize stable communication in the in-vehicle network.

(15) A vehicle communication method according to the embodiment of the present disclosure is a method used in an in-vehicle communication system including a plurality of in-vehicle devices each being connected to a first network and a second network. Each of the in-vehicle devices transmits and receives information to and from another in-vehicle device via the first network and the second network. The method includes: a step in which the in-vehicle device transmits the same control information related to control of a vehicle or in-vehicle equipment to both the first network and the second network; and a step in which the other in-vehicle device detects an overlap between the control information received from the first network and the control information received from the second network, and discards one of the control information received from the first network and the control information received from the second network.

In this method, even when an abnormality occurs in one of the first network and the second network, the highly important information related to control of the vehicle or the in-vehicle equipment can be transmitted and received via the other network. Moreover, the reception-side in-vehicle device is prevented from performing duplicate processing on the same information. Thus, it is possible to realize stable communication in the in-vehicle network.

Hereinafter, embodiments of the present disclosure will be described with reference to the drawings. In the drawings, the same or corresponding parts are denoted by the same reference signs, and descriptions thereof are not repeated. At least some parts of the embodiments described below can be combined together as desired.

### In-Vehicle Communication System

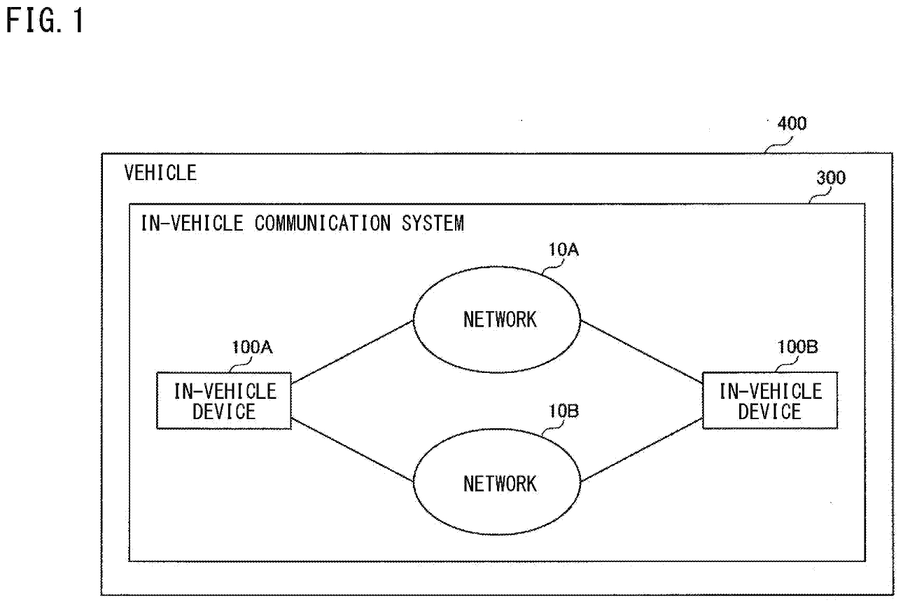

FIG. 1 shows a configuration of an in-vehicle communication system according to the embodiment of the present disclosure.

With reference to FIG. 1, an in-vehicle communication system 300 includes in-vehicle devices 100A, 100B. The in-vehicle communication system 300 is installed on a vehicle 400. Hereinafter, each of the in-vehicle devices 100A, 100B is also referred to as an in-vehicle device 100.

Examples of the in-vehicle device 100 include an automated driving ECU (Electronic Control Unit), an engine ECU, an accelerator control ECU, a brake control ECU, a steering control ECU, a navigation device, a human-machine interface, and a TCU (Telematics Communication Unit).

Each in-vehicle device 100 is connected to a network 10A and a network 10B. The in-vehicle device 100 transmits and receives information via the network 10A and the network 10B.

The network 10A is an example of a first network, and the network 10B is an example of a second network. The network 10A is, for example, a network in which Ethernet frames are transmitted and received according to the Ethernet (registered trademark) communication standard. The network 10B is, for example, a network in which frames are transmitted and received according to the CAN communication standard.

The in-vehicle device 100 transmits and receives, for example, information related to control of the vehicle 400 or in-vehicle equipment, image information, sound information, navigation information, and vehicle information including the traveling speed, the engine rotation speed, etc., of the vehicle 400.

The in-vehicle device 100 transmits and receives, for example, information for controlling the engine ECU, the accelerator control ECU, the brake control ECU, or the steering control ECU, as the information related to control of the vehicle 400 or the in-vehicle equipment. Hereinafter, the information related to control of the vehicle 400 or the in-vehicle equipment is also referred to as control information.

The in-vehicle device 100 can transmit the same information to the network 10A and the network 10B in parallel.

The clause “the in-vehicle device 100 transmits the same information to the network 10A and the network 10B in parallel” means that the in-vehicle device 100 transmits generated information to both the network 10A and the network 10B. That is, the in-vehicle device 100 may simultaneously transmit the same information to the respective networks, or a timing at which the in-vehicle device 100 starts to transmit the information to the network 10A may not necessarily coincide in time with a timing at which the in-vehicle device 100 starts to transmit the information to the network 10B. The in-vehicle device 100 may transmit communication signals including the same information to the respective networks over different lengths of time, or may transmit the communication signals to the respective networks over the same length of time.

For example, the in-vehicle device 100 transmits the control information, out of the information to be transmitted to the network 10A, to the network 10A and the network 10B in parallel.

The in-vehicle communication system 300 may not necessarily include two in-vehicle devices 100, and may include three or more in-vehicle devices 100.

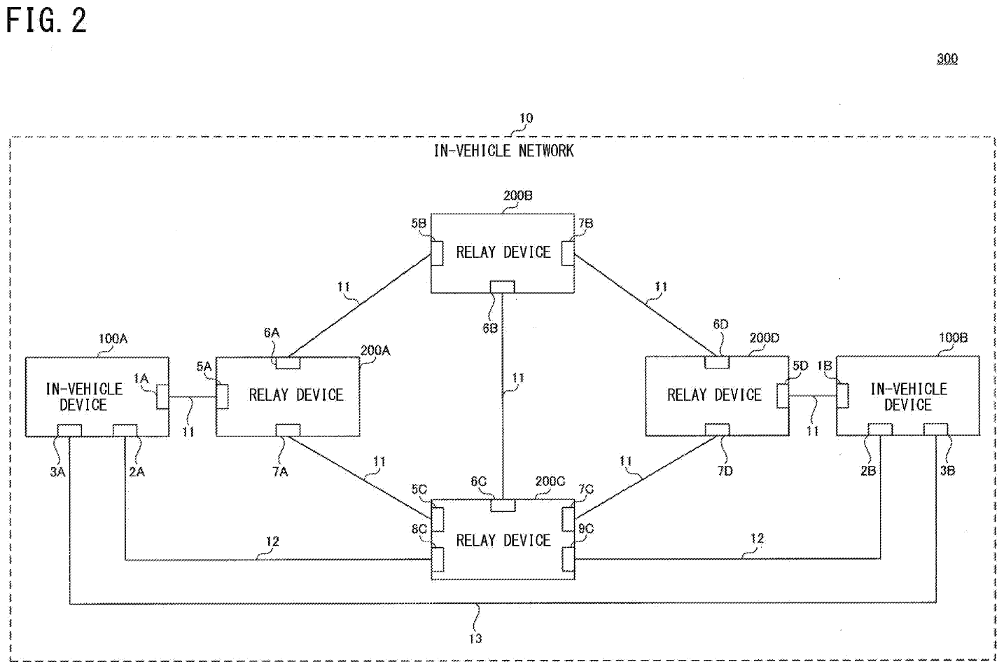

FIG. 2 shows the specific configuration of the in-vehicle communication system according to the embodiment of the present disclosure.

With reference to FIG. 2, the in-vehicle communication system 300 includes the in-vehicle device 100A, 100B, and relay devices 200A, 200B, 200C, 200D. Hereinafter, each of the relay devices 200A, 200B, 200C, 200D is also referred to as a relay device 200. The in-vehicle devices 100 and the relay devices 200 constitute an in-vehicle network 10.

The in-vehicle device 100A includes communication ports 1A, 2A, 3A. The in-vehicle device 100B includes communication ports 1B, 2B, 3B. Hereinafter, each of the communication port 1A and the communication port 1B is also referred to as a communication port 1, each of the communication port 2A and the communication port 2B is also referred to as a communication port 2, and each of the communication port 3A and the communication port 3B is also referred to as a communication port 3. The communication ports 1, 2, 3 are terminals to which various transmission lines are connectable.

The relay device 200A includes communication ports 5A, 6A, 7A. The relay device 200B includes communication ports 5B, 6B, 7B. The relay device 200C includes communication ports 5C, 6C, 7C, 8C, 9C. The relay device 200D includes communication ports 5D, 6D, 7D. The communication ports 5A, 6A, 7A, 5B, 6B, 7B, 5C, 6C, 7C, 8C, 9C, 5D, 6D, 7D are terminals to which various transmission lines are connectable.

The communication port 6A of the relay device 200A and the communication port 5B of the relay device 200B are connected to each other via an Ethernet cable 11.

The communication port 7A of the relay device 200A and the communication port 5C of the relay device 200C are connected to each other via an Ethernet cable 11.

The communication port 7B of the relay device 200B and the communication port 6D of the relay device 200D are connected to each other via an Ethernet cable 11.

The communication port 7C of the relay device 200C and the communication port 7D of the relay device 200D are connected to each other via an Ethernet cable 11.

The communication port 6B of the relay device 200B and the communication port 6C of the relay device 200C are connected to each other via an Ethernet cable 11.

Each relay device 200 is, for example, a gateway device that can relay information between the in-vehicle devices 100. The relay device 200 can perform a relay process according to, for example, a layer 2 and a layer 3 that is higher in order than the layer 2.

In more detail, the relay device 200 performs an Ethernet frame relaying process according to the Ethernet communication standard. Specifically, the relay device 200 relays an Ethernet frame exchanged between the in-vehicle devices 100, for example. An IP (Internet Protocol) packet is stored in the Ethernet frame.

The relay device 200C performs a frame relaying process according to the CAN communication standard. Hereinafter, a frame according to the CAN communication standard is also referred to as a CAN frame. The relay device 200C relays a CAN frame exchanged between the in-vehicle devices 100, for example.

The in-vehicle network 10 includes an Ethernet network as an example of the network 10A shown in FIG. 1, and a CAN as an example of the network 10B shown in FIG. 1.

The in-vehicle device 100 is connected to the Ethernet network, and transmits and receives information via the Ethernet network.

In more detail, the communication port 1A of the in-vehicle device 100A is connected to the communication port 5A of the relay device 200A via an Ethernet cable 11.

The communication port 1B of the in-vehicle device 100B is connected to the communication port 5D of the relay device 200D via an Ethernet cable 11.

The in-vehicle device 100 is connected to the CAN, and transmits and receives information via the CAN.

In more detail, the communication port 2A of the in-vehicle device 100A is connected to the communication port 8C of the relay device 200C via a CAN bus 12 that is a bus according to the CAN standard.

The communication port 2B of the in-vehicle device 100B is connected to the communication port 9C of the relay device 200C via the CAN bus 12.

The in-vehicle device 100 can transmit the same information to the Ethernet network and the CAN in parallel.

The communication port 3A of the in-vehicle device 100A and the communication port 3B of the in-vehicle device 100B are connected to each other via a coaxial cable 13. The coaxial cable 13 is an example of a dedicated line.

For example, the in-vehicle device 100 transmits information not to be transmitted via the Ethernet network and the CAN, out of the information related to control of the vehicle 400 or the in-vehicle equipment, to another in-vehicle device 100 via the coaxial cable 13.

The in-vehicle communication system 300 may not necessarily include four relay devices 200, and may include one, two, or more than four relay devices 200.

### In-Vehicle Device

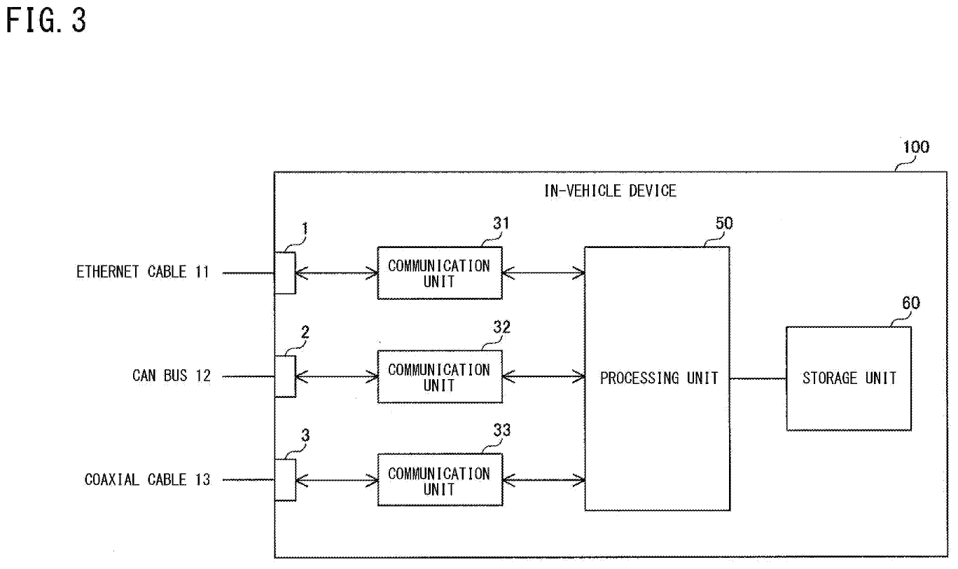

FIG. 3 shows a configuration of an in-vehicle device according to the embodiment of the present disclosure.

With reference to FIG. 3, the in-vehicle device 100 includes communication units 31, 32, 33, a processing unit 50, a storage unit 60, and communication ports 1, 2, 3. The storage unit 60 is a flash memory, for example. The communication unit 31 is an example of a first communication unit. The communication unit 32 is an example of a second communication unit.

As described above, the communication port 1 is connected to the relay device 200 via the Ethernet cable 11, the communication port 2 is connected to the relay device 200C via the CAN bus 12, and the communication port 3 is connected to another in-vehicle device 100 via the coaxial cable 13.

### Transmission Operation

The processing unit 50 can generate information to be transmitted to another in-vehicle device 100, and transmit the generated information to the other in-vehicle device 100 via the communication units 31, 32, 33.

For example, the processing unit 50 generates an Ethernet frame including the information to be transmitted to the other in-vehicle device 100.

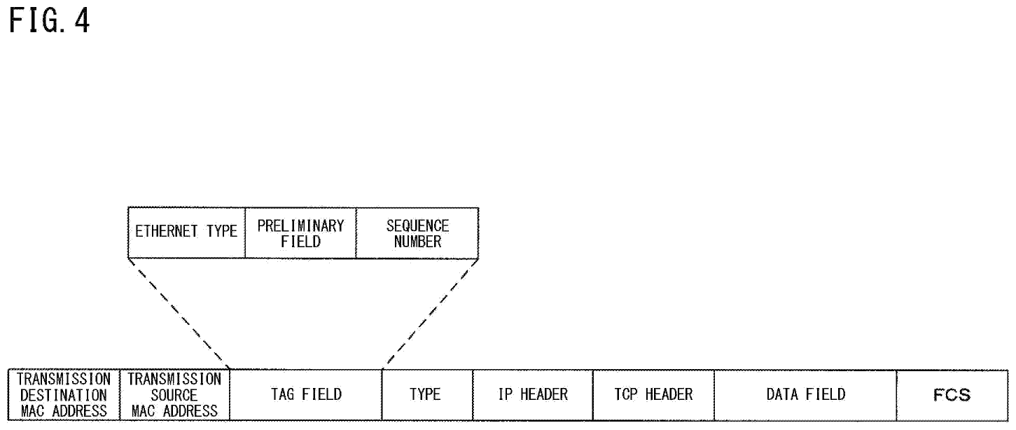

FIG. 4 shows an example of an Ethernet frame generated by the processing unit in the in-vehicle device according to the embodiment of the present disclosure.

With reference to FIG. 4, the Ethernet frame includes a transmission destination MAC (Media Access Control) address, a transmission source MAC address, a tag field, a type, an IP header, a TCP (Transmission Control Protocol) header, a data field, and an FCS (Frame Check Sequence).

In the tag field, an Ethernet type, a preliminary field, and a sequence number are stored.

The processing unit 50 generates the Ethernet frame in which the information to be transmitted to the other in-vehicle device 100 is stored in the data field, and outputs the generated Ethernet frame to the communication unit 31.

The communication unit 31 transmits the information generated by the processing unit 50 to the other in-vehicle device 100 via the Ethernet network. In more detail, upon receiving the Ethernet frame from the processing unit 50, the communication unit 31 transmits the received Ethernet frame to the Ethernet network via the communication port 1.

Moreover, the processing unit 50 generates a CAN frame including the information to be transmitted to the other in-vehicle device 100.

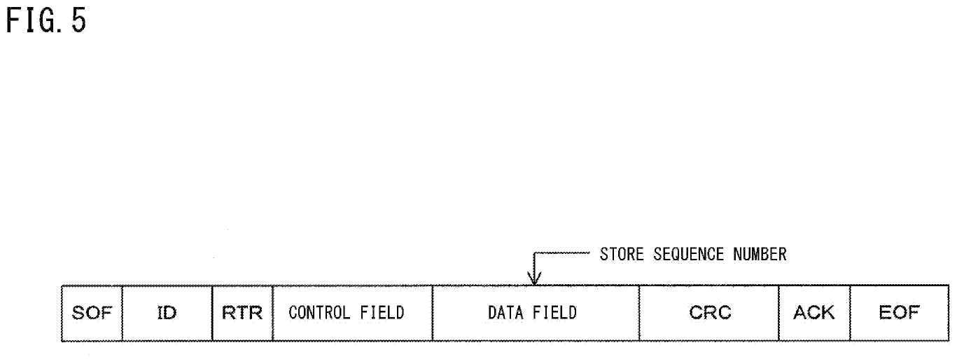

FIG. 5 shows an example of a CAN frame generated by the processing unit in the in-vehicle device according to the embodiment of the present disclosure.

With reference to FIG. 5, the CAN frame includes an SOF (Start Of Frame), an ID, an RTR (Remote Transmission Request), a control field, a data field, a CRC (Cyclic Redundancy Check), an ACK, and an EOF (End Of Frame).

The processing unit 50 generates the CAN frame in which the information to be transmitted to the other in-vehicle device 100 is stored in the data field, and outputs the generated CAN frame to the communication unit 32.

The communication unit 32 transmits the information generated by the processing unit 50 to the other in-vehicle device 100 via the CAN. In more detail, upon receiving the CAN frame from the processing unit 50, the communication unit 32 transmits the received CAN frame to the CAN via the communication port 2.

Moreover, the processing unit 50 outputs, to the communication unit 33, the information to be transmitted to the other in-vehicle device 100.

Upon receiving the information from the processing unit 50, the communication unit 33 generates a communication signal including the received information, and transmits the generated communication signal to the other in-vehicle device 100 via the communication port 3 and the coaxial cable 13.

For example, depending on the content of the information to be transmitted to the other in-vehicle device 100, the processing unit 50 determines via which route the information should be transmitted, among the communication unit 31 and the Ethernet network, the communication unit 32 and the CAN, and the communication unit 33 and the coaxial cable 13.

Specifically, the processing unit 50 transmits, for example, image information, sound information, navigation information, a part of control information, or the like to the other in-vehicle device 100 via the communication unit 31 and the Ethernet network. The processing unit 50 transmits, for example, vehicle information or the like, to the other in-vehicle device 100 via the communication unit 32 and the CAN.

The processing unit 50 transmits, for example, a part, out of the control information, which is not transmitted via the Ethernet network and the CAN, to the other in-vehicle device 100 via the communication unit 33 and the coaxial cable 13.

The communication unit 31 and the communication unit 32 can transmit, in parallel, the same information generated by the processing unit 50.

The clause “the communication unit 31 and the communication unit 32 transmit the same information in parallel” means that the communication unit 31 and the communication unit 32 respectively transmit the same information generated by the processing unit 50 to the corresponding networks. That is, the communication unit 31 and the communication unit 32 may not necessarily transmit the same information simultaneously to the Ethernet network and the CAN. A timing at which the communication unit 31 starts to transmit the information to the Ethernet network may not necessarily coincide in time with a timing at which the communication unit 32 starts to transmit the information to the CAN. The transmission timing of the communication unit 31 and the transmission timing of the communication unit 32 may or may not be synchronized with each other.

### Specific Example 1 of Transmission Operation

The in-vehicle device 100 transmits the same information to both the Ethernet network and the CAN.

In more detail, the processing unit 50 generates an Ethernet frame and a CAN frame including the same information, and outputs the generated Ethernet frame and CAN frame to the communication unit 31 and the communication unit 32, respectively.

The communication unit 31 transmits the Ethernet frame received from the processing unit 50 to the Ethernet network via the communication port 1. The communication unit 32 transmits the CAN frame received from the processing unit 50 to the CAN via the communication port 2.

The processing unit 50 selectively transmits a part of the information to be transmitted to the Ethernet network, to the Ethernet network and the CAN in parallel.

In more detail, the processing unit 50 transmits the control information, out of the information to be transmitted to the Ethernet network, to the Ethernet network and the CAN in parallel.

The processing unit 50 adds the same sequence number to the pieces of information to be transmitted to the Ethernet network and the CAN in parallel.

In more detail, the processing unit 50 generates: an Ethernet frame including the information to be transmitted in parallel, and the sequence number; and a CAN frame in which the above information and the same sequence number as above are stored in the data field. The processing unit 50 increments the sequence number in units of frames, for example.

The processing unit 50 transmits the generated Ethernet frame to the Ethernet network via the communication unit 31, and transmits the generated CAN frame to the CAN via the communication unit 32.

### Specific Example 2 of Transmission Operation

The in-vehicle device 100 transmits, for example, the image information, the sound information, the navigation information, a part of the control information, or the like to the Ethernet network. Moreover, the in-vehicle device 100 transmits, for example, the vehicle information or the like, to the CAN.

In more detail, the processing unit 50 generates an Ethernet frame including the image information, the sound information, the navigation information, or a part of the control information, and transmits the generated Ethernet frame to the Ethernet network via the communication unit 31.

The processing unit 50 detects an abnormality in the Ethernet network, based on whether or not an acknowledgement frame for the transmitted Ethernet frame has been received from the reception-side in-vehicle device 100.

In more detail, the processing unit 50 determines that the Ethernet network is normal, when it has received the acknowledgement frame for the transmitted Ethernet frame, from the reception-side in-vehicle device 100 via the communication unit 31.

Meanwhile, the processing unit 50 determines that an abnormality occurs in the Ethernet network, when it has not received an acknowledgement frame for the transmitted Ethernet frame, via the communication unit 31, within a predetermined time from the transmission of the Ethernet frame.

Upon detecting an abnormality in the Ethernet network, the processing unit 50 switches transmission of information via the Ethernet network to transmission of information via the CAN.

In more detail, the processing unit 50 selectively switches transmission of the control information, which is a part of the transmission of information via the Ethernet network, to transmission of the control information via the CAN.

Thereafter, the processing unit 50 generates, for example, new image information, sound information, or navigation information to be transmitted, and transmits an Ethernet frame including the generated new information to the Ethernet network via the communication unit 31. When the processing unit 50 has received an acknowledgement frame for the transmitted Ethernet frame via the communication unit 31, the processing unit 50 determines that the Ethernet network is restored.

Upon determining that the Ethernet network is restored, the processing unit 50 switches transmission of the control information to another in-vehicle device 100 via the CAN, to transmission of the control information via the Ethernet network.

### Reception Operation

The communication unit 31 receives information from the Ethernet network. In more detail, the communication unit 31 receives an Ethernet frame via the communication port 1. The communication unit 31 outputs the received Ethernet frame to the processing unit 50.

The processing unit 50 performs a process using the information received by the communication unit 31. In more detail, upon receiving the Ethernet frame from the communication unit 31, the processing unit 50 acquires information from the data field of the received Ethernet frame, and performs the process using the acquired information.

Meanwhile, the processing unit 50 generates an acknowledgement frame for an Ethernet frame received from another in-vehicle device 100 via the communication unit 31 and the Ethernet network, and transmits the generated acknowledgement frame to the other in-vehicle device 100 via the communication unit 31 and the Ethernet network.

The communication unit 32 receives information from the CAN. In more detail, the communication unit 32 receives a CAN frame via the communication port 2. The communication unit 32 outputs the received CAN frame to the processing unit 50.

The processing unit 50 performs a process using the information received by the communication unit 32. In more detail, upon receiving the CAN frame from the communication unit 32, the processing unit 50 acquires information from the data field of the CAN frame, and performs the process using the acquired information.

When the information received from the Ethernet network via the communication unit 31 overlaps the information received from the CAN via the communication unit 32, the processing unit 50 discards one of the information received from the Ethernet network and the information received from the CAN.

For example, the processing unit 50 detects, by using the sequence numbers included in the pieces of information respectively received from the Ethernet network and the CAN, an overlap of the pieces of information received.

In more detail, the processing unit 50 creates a number list A1 in which the sequence numbers included in the tags of the Ethernet frames received from the communication unit 31 are recorded, and stores the created number list A1 in the storage unit 60. Moreover, the processing unit 50 creates a number list A2 in which the sequence numbers included in the data fields of the CAN frames received from the communication unit 32 are recorded, and stores the created number list A2 in the storage unit 60.

The processing unit 50 checks the sequence number of an Ethernet frame received from the communication unit 31 against the number list A2, and checks the sequence number of a CAN frame received from the communication unit 32 against the number list A1, thereby detecting an overlap of the pieces of information received.

For example, upon receiving an Ethernet frame from the communication unit 31, the processing unit 50 acquires the sequence number included in the tag of the received Ethernet frame, and adds the acquired sequence number to the number list A1 in the storage unit 60 to update the number list A1.

Then, the processing unit 50 checks the sequence number acquired from the Ethernet frame against the number list A2 in the storage unit 60. When the same number as the acquired sequence number is included in the number list A2 in the storage unit 60, the processing unit 50 discards the Ethernet frame.

Meanwhile, when the same number as the acquired sequence number is not included in the number list A2 in the storage unit 60, the processing unit 50 acquires information included in the data field of the Ethernet frame corresponding to the sequence number, and performs the process using the acquired information.

Likewise, upon receiving a CAN frame from the communication unit 32, the processing unit 50 acquires the sequence number included in the data field of the received CAN frame, and adds the acquired sequence number to the number list A2 in the storage unit 60 to update the number list A2.

The processing unit 50 checks the sequence number acquired from the CAN frame against the number list A1 in the storage unit 60. When the same number as the acquired sequence number is included in the number list A1 in the storage unit 60, the processing unit 50 discards the CAN frame.

Meanwhile, when the same number as the acquired sequence number is not included in the number list A1 in the storage unit 60, the processing unit 50 acquires information included in the data field of the CAN frame corresponding to the sequence number, and performs the process using the acquired information.

Here, as an example, the processing unit 50 creates a number list A1 having, recorded therein, the sequence numbers included in the tags of the Ethernet frames received from the communication unit 31, and the reception times of the Ethernet frames, and stores the created number list A1 in the storage unit 60. Moreover, the processing unit 50 creates a number list A2 having, recorded therein, the sequence numbers included in the data fields of the CAN frames received from the communication unit 32, and the reception times of the CAN frames, and stores the created number list A2 in the storage unit 60.

Of the sequence numbers recorded in the number lists A1 and A2, the processing unit 50 sets the sequence numbers corresponding to the reception times within a predetermined period from the present time, as target sequence numbers to be checked against the Ethernet frame or the CAN frame as described above.

### Operation Flow

Each of the devices in the in-vehicle communication system according to the embodiment of the present disclosure is provided with a computer including a memory. An arithmetic processing unit such as a CPU in the computer reads out a program including a part or all of steps in the following flowcharts and sequences from the memory, and executes the program. The programs for the plurality of devices can be installed from outside. The programs for the plurality of devices are distributed in a state of being stored in a storage medium.

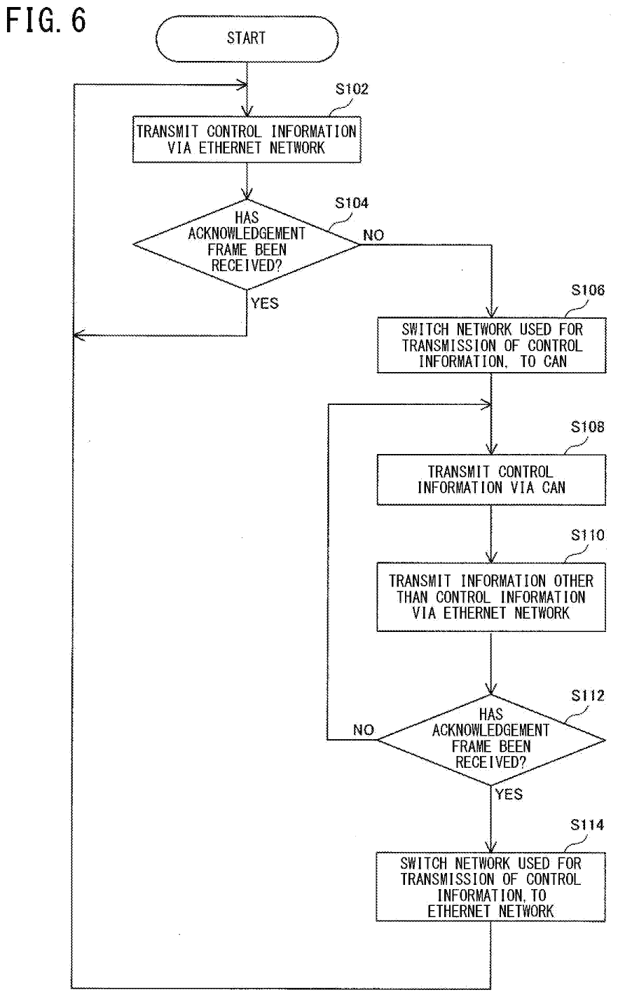

FIG. 6 is a flowchart of an example of an operation procedure when an in-vehicle device transmits information to another in-vehicle device in the in-vehicle communication system according to the embodiment of the present disclosure.

With reference to FIG. 6, firstly, an in-vehicle device 100A transmits control information to an in-vehicle device 100B via an Ethernet network. Specifically, the in-vehicle device 100A generates an Ethernet frame including the control information to be transmitted, and transmits the generated Ethernet frame to the in-vehicle device 100B via the Ethernet network (step S102).

Next, when the in-vehicle device 100A has received an acknowledgement frame within a predetermined time from the transmission of the control information to the in-vehicle device 100B (YES in step S104), the in-vehicle device 100A continues transmission and reception of the control information using the Ethernet network to and from the in-vehicle device 100B (step S102).

On the other hand, if the in-vehicle device 100A has not received an acknowledgement frame within the predetermined time from the transmission of the control information to the in-vehicle device 100B (NO in step S104), the in-vehicle device 100A determines that an abnormality occurs in the Ethernet network, and switches the network used for transmitting the control information, from the Ethernet network to the CAN (step S106).

Next, the in-vehicle device 100A transmits the control information to the in-vehicle device 100B via the CAN. Specifically, the in-vehicle device 100A generates a CAN frame including the control information to be transmitted, and transmits the generated CAN frame to the in-vehicle device 100B via the CAN (step S108).

Next, the in-vehicle device 100A transmits information (e.g., image information) other than the control information to the in-vehicle device 100B via the Ethernet network. Specifically, the in-vehicle device 100A generates an Ethernet frame including the image information to be transmitted, and transmits the generated Ethernet frame to the in-vehicle device 100B via the Ethernet network (step S110).

If the in-vehicle device 100A has not received an acknowledgement frame within a predetermined time from the transmission of the image information to the in-vehicle device 100B (NO in step S112), the in-vehicle device 100A transmits new control information to the in-vehicle device 100B via the CAN (step S108), and transmits new image information to the in-vehicle device 100B via the Ethernet network (step S110).

On the other hand, when the in-vehicle device 100A has received an acknowledgement frame within the predetermined time from the transmission of the image information to the in-vehicle device 100B (YES in step S112), the in-vehicle device 100A determines that the Ethernet network is restored, switches the network used for transmitting the control information, from the CAN to the Ethernet network (step S114), and transmits new control information to the in-vehicle device 100B via the Ethernet network (S102).

The order of steps S108 and S110 is not limited to the order described above, and may be interchanged.

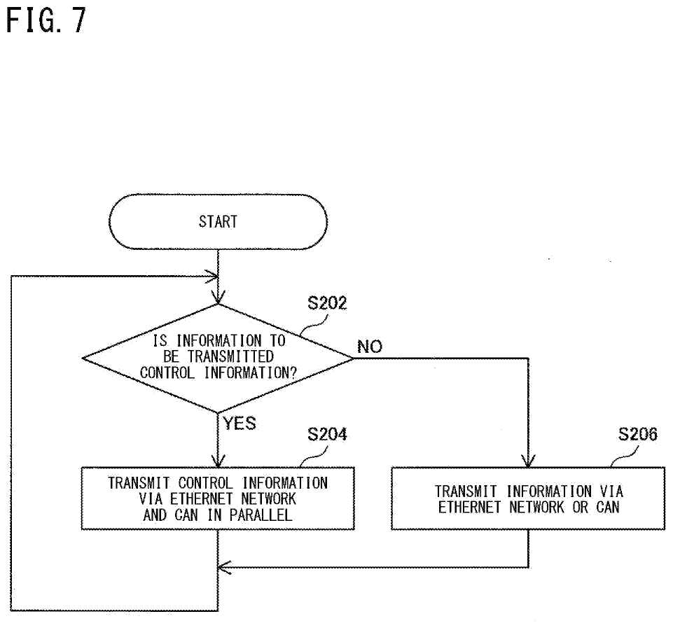

FIG. 7 is a flowchart of another example of an operation procedure when an in-vehicle device transmits information to another in-vehicle device in the in-vehicle communication system according to the embodiment of the present disclosure.

With reference to FIG. 7, firstly, the in-vehicle device 100A checks whether or not information to be transmitted to the in-vehicle device 100B is control information (step S202).

When the information to be transmitted is the control information (YES in step S202), the in-vehicle device 100A transmits the control information to the in-vehicle device 100B via the Ethernet network and the CAN in parallel. Specifically, the in-vehicle device 100A generates an Ethernet frame and a CAN frame each including the control information to be transmitted, transmits the generated Ethernet frame to the in-vehicle device 100B via the Ethernet network, and transmits the generated CAN frame to the in-vehicle device 100B via the CAN (step S204).

Next, the in-vehicle device 100A checks whether or not next information to be transmitted is control information (step S202).

When the information to be transmitted is information other than the control information (NO in step S202), the in-vehicle device 100A transmits the information via one of the Ethernet network and the CAN. Specifically, the in-vehicle device 100A generates an Ethernet frame including image information to be transmitted, and transmits the generated Ethernet frame to the in-vehicle device 100B via the Ethernet network. Alternatively, the in-vehicle device 100A generates a CAN frame including vehicle information to be transmitted, and transmits the generated CAN frame to the in-vehicle device 100B via the CAN (step S206).

Next, the in-vehicle device 100A checks whether or not next information to be transmitted is control information (step S202).

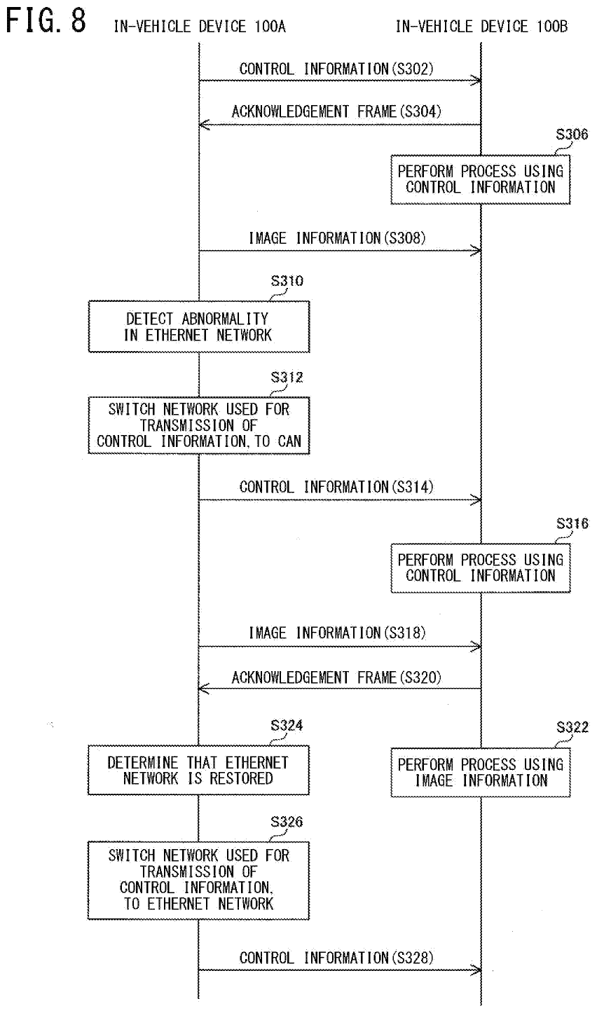

FIG. 8 shows an example of a sequence of a process when an in-vehicle device transmits information to another in-vehicle device in the in-vehicle communication system according to the embodiment of the present disclosure. FIG. 8 shows the sequence of the process in the specific example 2 of the transmission operation described above.

With reference to FIG. 8, firstly, the in-vehicle device 100A transmits information such as control information to the in-vehicle device 100B via the Ethernet network. Specifically, the in-vehicle device 100A generates an Ethernet frame including the control information to be transmitted, and transmits the generated Ethernet frame to the in-vehicle device 100B via the Ethernet network (step S302).

Next, the in-vehicle device 100B transmits an acknowledgement frame for the Ethernet frame received from the in-vehicle device 100A, to the in-vehicle device 100A via the Ethernet network (step S304).

Next, the in-vehicle device 100B performs a predetermined process by using the control information included in the Ethernet frame received from the in-vehicle device 100A (step S306).

Next, the in-vehicle device 100A transmits information such as image information to the in-vehicle device 100B via the Ethernet network (step S308).

If the in-vehicle device 100A has not received an acknowledgement frame within a predetermined time from the transmission of the image information to the in-vehicle device 100B, the in-vehicle device 100A detects that an abnormality occurs in the Ethernet network (step S310).

Next, the in-vehicle device 100A switches the network used for transmitting the control information to the in-vehicle device 100B, from the Ethernet network to the CAN (step S312).

Next, the in-vehicle device 100A transmits the control information to the in-vehicle device 100B via the CAN. Specifically, the in-vehicle device 100A generates a CAN frame including the control information to be transmitted, and transmits the generated CAN frame to the in-vehicle device 100B via the CAN (step S314).

Next, the in-vehicle device 100B performs a predetermined process by using the control information included in the CAN frame received from the in-vehicle device 100A (step S316).

Next, the in-vehicle device 100A transmits information (e.g., image information) other than the control information to the in-vehicle device 100B via the Ethernet network. Specifically, the in-vehicle device 100A generates an Ethernet frame including the image information to be transmitted, and transmits the generated Ethernet frame to the in-vehicle device 100B via the Ethernet network (step S318).

Next, the in-vehicle device 100B transmits, to the in-vehicle device 100A, an acknowledgement frame for the Ethernet frame received from the in-vehicle device 100A (step S320).

Next, the in-vehicle device 100B performs a predetermined process by using the image information included in the Ethernet frame received from the in-vehicle device 100A (step S322).

Upon receiving the acknowledgement frame from the in-vehicle device 100B, the in-vehicle device 100A determines that the Ethernet network is restored (step S324).

Next, the in-vehicle device 100A switches the network used for transmitting the control information to the in-vehicle device 100B, from the CAN to the Ethernet network (step S326).

Next, the in-vehicle device 100A transmits control information to the in-vehicle device 100B via the Ethernet network (step S328).

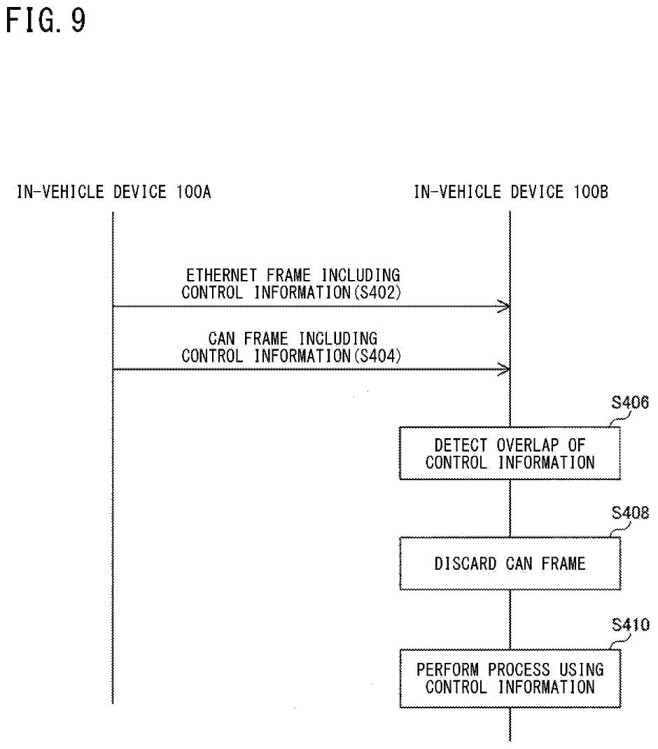

FIG. 9 shows another example of a sequence of a process when an in-vehicle device transmits information to another in-vehicle device in the in-vehicle communication system according to the embodiment of the present disclosure. FIG. 9 shows the sequence of the process in the specific example 1 of the transmission operation described above.

With reference to FIG. 9, firstly, the in-vehicle device 100A transmits the same control information to the in-vehicle device 100B via the Ethernet network and the CAN in parallel. Specifically, the in-vehicle device 100A transmits an Ethernet frame including the control information to the in-vehicle device 100B via the Ethernet network (step S402), and transmits a CAN frame including the control information to the in-vehicle device 100B via the CAN (step S404).

Upon receiving the Ethernet frame and the CAN frame from the in-vehicle device 100A, the in-vehicle device 100B detects an overlap between the control information included in the Ethernet frame and the control information included in the CAN frame (step S406).

Next, the in-vehicle device 100B discards, for example, the CAN frame, between the Ethernet frame and the CAN frame received from the in-vehicle device 100A (step S408).

Next, the in-vehicle device 100B performs a predetermined process by using the control information included in the Ethernet frame received from the in-vehicle device 100A (step S410).

In the in-vehicle communication system 300 according to the embodiment of the present disclosure, the in-vehicle devices 100A, 100B can transmit the same information to the Ethernet network and the CAN in parallel. However, the present disclosure is not limited thereto. At least one of the in-vehicle devices 100 in the in-vehicle communication system 300 may be able to transmit the same information to the Ethernet network and the CAN in parallel. For example, the in-vehicle device 100A may be able to transmit the same information to the Ethernet network and the CAN in parallel while the in-vehicle device 100B may be unable to transmit the same information to the Ethernet network and the CAN in parallel.

In the in-vehicle communication system 300 according to the embodiment of the present disclosure, the in-vehicle device 100 performs: the operation of switching transmission of control information to another in-vehicle device via the Ethernet network, to transmission of the control information via the CAN; and the operation of transmitting the same information to both the Ethernet network and the CAN. However, the present disclosure is not limited thereto.

The in-vehicle device 100 may not necessarily perform the operation of transmitting the same information to both the Ethernet network and the CAN, while performing the operation of switching transmission of the control information to the other in-vehicle device via the Ethernet network, to transmission of the control information via the CAN.

Alternatively, the in-vehicle device 100 may not necessarily perform the operation of switching transmission of the control information to the other in-vehicle device via the Ethernet network, to transmission of the control information via the CAN, while performing the operation of transmitting the same information to both the Ethernet network and the CAN.

In the in-vehicle communication system 300 according to the embodiment of the present disclosure, the in-vehicle device 100, upon detecting an abnormality in the Ethernet network, switches transmission of information via the Ethernet network to transmission of the information via the CAN. However, the present disclosure is not limited thereto. Upon detecting an abnormality in the Ethernet network, the in-vehicle device 100 may transmit the same information to the Ethernet network and the CAN in parallel.

In the in-vehicle communication system 300 according to the embodiment of the present disclosure, when the information received from the Ethernet network overlaps the information received from the CAN, the in-vehicle device 100 discards one of the information received from the Ethernet network and the information received from the CAN. However, the present disclosure is not limited thereto. The in-vehicle device 100 may not necessarily discard the overlapping information.

In the in-vehicle communication system 300 according to the embodiment of the present disclosure, the in-vehicle device 100 detects, by using the sequence numbers included in the information received from the Ethernet network and the information received from the CAN, an overlap of these pieces of information. However, the present disclosure is not limited thereto. The in-vehicle device 100 may detect the overlap by using information other than the sequence numbers.

In the in-vehicle communication system 300 according to the embodiment of the present disclosure, when the in-vehicle device 100 has detected an abnormality in the Ethernet network, the in-vehicle device 100 switches transmission of control information, which is a part of transmission of pieces of information to another in-vehicle device 100 via the Ethernet network, to transmission of the control information via the CAN. However, the present disclosure is not limited thereto. When detecting an abnormality in the Ethernet network, the in-vehicle device 100 may switch transmission of all pieces of information to the other in-vehicle device 100 via the Ethernet network, to transmission via the CAN.

In the in-vehicle communication system 300 according to the embodiment of the present disclosure, the in-vehicle device 100 selectively transmits a part of information to be transmitted to the Ethernet network, to the Ethernet network and the CAN in parallel. However, the present disclosure is not limited thereto. The in-vehicle device 100 may transmit all pieces of information to be transmitted to the Ethernet network to the Ethernet network and the CAN in parallel.

In the in-vehicle communication system 300 according to the embodiment of the present disclosure, the in-vehicle device 100 transmits the control information, out of the pieces of information to be transmitted to the Ethernet network, to the Ethernet network and the CAN in parallel. However, the present disclosure is not limited thereto. The in-vehicle device 100 may transmit information different from the control information to the Ethernet network and the CAN in parallel without transmitting the control information to the Ethernet network and the CAN in parallel.

In the in-vehicle communication system 300 according to the embodiment of the present disclosure, the in-vehicle device 100 transmits a part, of the control information, which is not transmitted via the Ethernet network and the CAN, to another in-vehicle device 100 via a dedicated line. However, the present disclosure is not limited thereto. The in-vehicle device 100 may not necessarily perform transmission of the control information to the other in-vehicle device 100 via the dedicated line.

In the in-vehicle communication system 300 according to the embodiment of the present disclosure, the in-vehicle device 100A and the in-vehicle device 100B are connected to each other via the coaxial cable 13. However, the present disclosure is not limited thereto. The in-vehicle communication system 300 may not necessarily include the coaxial cable 13. Specifically, the in-vehicle device 100A and the in-vehicle device 100B may not necessarily be connected to each other via the coaxial cable 13.

In the in-vehicle communication system 300 according to the embodiment of the present disclosure, the processing unit 50 in the in-vehicle device 100 detects an abnormality in the Ethernet network, based on whether or not an acknowledgement frame for a transmitted Ethernet frame has been received from the reception side in-vehicle device 100. However, the present disclosure is not limited thereto. The processing unit 50 may detect an abnormality in the Ethernet network by using a ping (Packet INternet Groper) which is a network diagnostic program using ICMP (Internet Control Message Protocol), for example.

Meanwhile, a technology capable of realizing stable communication in an in-vehicle network has been desired.

In response to this desire, the in-vehicle communication system 300 according to the embodiment of the present disclosure includes the plurality of in-vehicle devices 100 connected to the Ethernet network and the CAN. Each of the plurality of in-vehicle devices 100 transmits and receives information to and from another in-vehicle device 100 via the Ethernet network and the CAN. At least one of the plurality of in-vehicle devices 100 can transmit the same information to the Ethernet network and the CAN in parallel.

As described above, since the same information can be transmitted to the Ethernet network and the CAN in parallel, even when an abnormality occurs in one of the Ethernet network and the CAN, the information to be transmitted to the other in-vehicle device 100 via this network can be transmitted via the other network.

Therefore, in the in-vehicle communication system 300 according to the embodiment of the present disclosure, it is possible to realize stable communication in the in-vehicle network.

In the in-vehicle communication system 300 according to the embodiment of the present disclosure, upon detecting an abnormality in the Ethernet network, the in-vehicle device 100 switches transmission of information via the Ethernet network to transmission of the information via the CAN.

With this configuration, even when an abnormality occurs in the Ethernet network, it is possible to transmit the information via the CAN which has a higher resistance to noise that may occur in the in-vehicle network than the Ethernet network and which can construct a redundant path by using simple wiring.

In the in-vehicle communication system 300 according to the embodiment of the present disclosure, the in-vehicle device 100 transmits the same information to both the Ethernet network and the CAN. When the information received from the Ethernet network overlaps the information received from the CAN, the other in-vehicle device 100 discards one of the information received from the Ethernet network and the information received from the CAN.

With this configuration, it is possible to prevent the reception-side in-vehicle device 100 from performing duplicate processing on the information, while increasing the resistance to noise or the like by transmitting the same information to the respective networks.

In the in-vehicle communication system 300 according to the embodiment of the present disclosure, the transmission-side in-vehicle device 100 adds the same sequence number to the pieces of information to be transmitted to the Ethernet network and the CAN in parallel, and transmits the pieces of information. The reception-side in-vehicle device 100 detects an overlap of the pieces of information by using the sequence number included in the received information.

With this configuration, the reception-side in-vehicle device 100 can easily and reliably detect an overlap of the pieces of information received from both the networks. In the in-vehicle communication system 300 according to the embodiment of the present disclosure, the in-vehicle device 100 selectively transmits a part of the information to be transmitted to the Ethernet network, to the Ethernet network and the CAN in parallel.

With this configuration, for example, a part, having a higher priority, out of the information to be transmitted to the Ethernet network can be reliably transmitted to the reception-side in-vehicle device 100, while inhibiting an increase in communication traffic in the in-vehicle network.

In the in-vehicle communication system 300 according to the embodiment of the present disclosure, the in-vehicle device 100 transmits information related to control of the vehicle 400 or the in-vehicle equipment, out of the information to be transmitted to the Ethernet network, to the Ethernet network and the CAN in parallel.

With this configuration, the information related to control of the vehicle 400 or the in-vehicle equipment, which is highly important information, can be reliably transmitted to the reception-side in-vehicle device 100.

In the in-vehicle communication system 300 according to the embodiment of the present disclosure, the in-vehicle device 100 transmits information not to be transmitted via the Ethernet network and the CAN, out of the information related to control of the vehicle 400 or the in-vehicle equipment, to the other in-vehicle device 100 via the coaxial cable 13.

With this configuration, for example, information, whose allowable delay time is relatively short and which has a higher priority, can be reliably transmitted to the reception-side in-vehicle device 100, with reduced delay time, while stably transmitting other information by using the Ethernet network and the CAN.

The in-vehicle communication system 300 according to the embodiment of the present disclosure includes the plurality of in-vehicle devices 100 connected to the network 10A and the network 10B. Each of the plurality of in-vehicle devices 100 transmits and receives information to and from another in-vehicle device 100 via the network 10A and the network 10B. At least one of the plurality of in-vehicle devices 100 can transmit the same information related to control of the vehicle 400 or the in-vehicle equipment to the network 10A and the network 10B in parallel.

Since the same information related to control of the vehicle 400 or the in-vehicle equipment can be transmitted to the network 10A and the network 10B in parallel, even when an abnormality occurs in one of the network 10A and the network 10B, the highly important information to be transmitted via this network can be transmitted via the other network.

Therefore, in the in-vehicle communication system 300 according to the embodiment of the present disclosure, it is possible to realize stable communication in the in-vehicle network.

The in-vehicle device 100 according to the embodiment of the present disclosure is connected to the Ethernet network and the CAN. The processing unit 50 generates information to be transmitted to another in-vehicle device 100. The communication unit 31 transmits the information generated by the processing unit 50 to the other in-vehicle device 100 via the Ethernet network. The communication unit 32 transmits the information generated by the processing unit 50 to the other in-vehicle device 100 via the CAN. The communication unit 31 and the communication unit 32 can transmit the same information in parallel.

As described above, since the same information can be transmitted to the Ethernet network and the CAN in parallel, even when an abnormality occurs in one of the Ethernet network and the CAN, the information to be transmitted to the other in-vehicle device 100 via this network can be transmitted via the other network.

Therefore, the in-vehicle device 100 according to the embodiment of the present disclosure can realize stable communication in the in-vehicle network.

The in-vehicle device 100 according to the embodiment of the present disclosure is connected to the Ethernet network and the CAN. The communication unit 31 receives information from the Ethernet network. The communication unit 32 receives information from the CAN. The processing unit 50 can perform a process using the information received by the communication unit 31 and a process using the information received by the communication unit 32. When the information received by the communication unit 31 overlaps the information received by the communication unit 32, the processing unit 50 discards one of the information received by the communication unit 31 and the information received by the communication unit 32.

With this configuration, even when an abnormality occurs in one of the Ethernet network and the CAN, the information can be received from the other network. Moreover, when the same information is received from the two networks in an overlapping manner, it is possible to avoid duplicate processing on the information.

Therefore, the in-vehicle device 100 according to the embodiment of the present disclosure can realize stable communication in the in-vehicle network.

The in-vehicle device 100 according to the embodiment of the present disclosure is connected to the network 10A and the network 10B. The processing unit 50 generates information to be transmitted to another in-vehicle device 100. The communication unit 31 transmits the information generated by the processing unit 50 to the other in-vehicle device 100 via the network 10A. The communication unit 32 transmits the information generated by the processing unit 50 to the other in-vehicle device 100 via the network 10B. The communication unit 31 and the communication unit 32 can transmit, in parallel, the same information that is generated by the processing unit 50 and is related to control of the vehicle 400 or the in-vehicle equipment.

Since the same information related to control of the vehicle 400 or the in-vehicle equipment can be transmitted to the network 10A and the network 10B in parallel, even when an abnormality occurs in one of the network 10A and the network 10B, the highly important information to be transmitted to the other in-vehicle device 100 via this network can be transmitted via the other network.

Therefore, the in-vehicle device 100 according to the embodiment of the present disclosure can realize stable communication in the in-vehicle network.

The in-vehicle device 100 according to the embodiment of the present disclosure is connected to the network 10A and the network 10B. The communication unit 31 receives information from the network 10A. The communication unit 32 receives information from the network 10B. The processing unit 50 can perform a process using the information received by the communication unit 31 and a process using the information received by the communication unit 32. When control information that is related to the vehicle 400 or the in-vehicle equipment and is received by the communication unit 31 overlaps the control information that is related to the vehicle 400 or the in-vehicle equipment and is received by the communication unit 32, the processing unit 50 discards one of the control information received by the communication unit 31 and the control information received by the communication unit 32.

With this configuration, even when an abnormality occurs in one of the network 10A and the network 10B, the highly important information related to control of the vehicle 400 or the in-vehicle equipment can be received from the other network. Moreover, when the same information is received from the two networks in an overlapping manner, it is possible to avoid duplicate processing on the information.

Therefore, the in-vehicle device 100 according to the embodiment of the present disclosure can realize stable communication in the in-vehicle network.

The vehicle communication method according to the embodiment of the present disclosure is a vehicle communication method in the in-vehicle communication system 300 including the plurality of in-vehicle devices 100 each being connected to the Ethernet network and the CAN. Each of the in-vehicle devices 100 transmits and receives information to and from another in-vehicle device 100 via the Ethernet network and the CAN. In this vehicle communication method, initially, the in-vehicle device 100 detects an abnormality in the Ethernet network. Next, the in-vehicle device 100 having detected the abnormality switches transmission of the information to the other in-vehicle device 100 via the Ethernet network, to transmission of the information via the CAN.

In this method, even when an abnormality occurs in the Ethernet network, it is possible to transmit the information via the CAN which has a higher resistance to noise that may occur in the in-vehicle network than the Ethernet network and which can construct a redundant path by using simple wiring.

Therefore, in the vehicle communication method according to the embodiment of the present disclosure, it is possible to realize stable communication in the in-vehicle network.

The vehicle communication method according to the embodiment of the present disclosure is a vehicle communication method in the in-vehicle communication system including the plurality of in-vehicle devices each being connected to the Ethernet network and the CAN. Each of the in-vehicle devices 100 transmits and receives information to and from another in-vehicle device 100 via the Ethernet network and the CAN. In this vehicle communication method, firstly, the in-vehicle device 100 transmits the same information to both the Ethernet network and the CAN. Next, the other in-vehicle device 100 detects an overlap between the information received from the Ethernet network and the information received from the CAN, and discards one of the information received from the Ethernet network and the information received from the CAN.

In this method, even when an abnormality occurs in one of the Ethernet network and the CAN, the information can be transmitted and received via the other network. Moreover, the reception-side in-vehicle device 100 is prevented from performing duplicate processing on the same information.

Therefore, in the vehicle communication method according to the embodiment of the present disclosure, it is possible to realize stable communication in the in-vehicle network.

The vehicle communication method according to the embodiment of the present disclosure is a vehicle communication method in the in-vehicle communication system including the plurality of in-vehicle devices each being connected to the first network and the second network. Each of the in-vehicle devices 100 transmits and receives information to and from another in-vehicle device 100 via the network 10A and the network 10B. In this vehicle communication method, firstly, the in-vehicle device 100 transmits the same control information related to control of the vehicle 400 or the in-vehicle equipment to both the network 10A and the network 10B. Next, the other in-vehicle device 100 detects an overlap between the control information received from the network 10A and the control information received from the network 10B, and discards one of the control information received from the network 10A and the control information received from the network 10B.

In this method, even when an abnormality occurs in one of the first network and the second network, the highly important information related to control of the vehicle 400 or the in-vehicle equipment can be transmitted and received via the other network. Moreover, the reception-side in-vehicle device 100 is prevented from performing duplicate processing on the same information.

Therefore, in the vehicle communication method according to the embodiment of the present disclosure, it is possible to realize stable communication in the in-vehicle network.

The above embodiments are merely illustrative in all aspects and should not be recognized as being restrictive. The scope of the present disclosure is defined by the scope of the claims rather than by the description above, and is intended to include meaning equivalent to the scope of the claims and all modifications within the scope.

The above description includes the features in the additional notes below.

### Additional Note 1

An in-vehicle communication system including a plurality of in-vehicle devices each being connected to an Ethernet network and a CAN, wherein
each of the plurality of in-vehicle devices transmits and receives information to and from another in-vehicle device via the Ethernet network and the CAN, and
at least one of the plurality of in-vehicle devices, upon detecting an abnormality in the Ethernet network, switches transmission of control information via the Ethernet network to transmission of the control information via the CAN.

### Additional Note 2

A vehicle communication method in an in-vehicle device connected to an Ethernet network and a CAN, the method including:
generating information to be transmitted to another in-vehicle device; and
transmitting the same generated information to the other in-vehicle device via the Ethernet network and the CAN in parallel.

### Additional Note 3

A vehicle communication method in an in-vehicle device connected to an Ethernet network and a CAN, the method including:
receiving information from the Ethernet network;
receiving information from the CAN; and
when the information received from the Ethernet network overlaps the information received from the CAN, discarding one of the information received from the Ethernet network and the information received from the CAN.

### Additional Note 4

A vehicle communication method in an in-vehicle device connected to a first network and a second network, the method including:
generating information to be transmitted to another in-vehicle device; and
transmitting the same generated information, which is related to control of a vehicle or in-vehicle equipment, to the other in-vehicle device via the first network and the second network in parallel.

### Additional Note 5

A vehicle communication method in an in-vehicle device connected to a first network and a second network, the method including:
receiving information from the first network;
receiving information from the second network; and
when control information that is related to control of a vehicle or in-vehicle equipment and is received from the first network overlaps the control information that is related to control of the vehicle or the in-vehicle equipment and is received from the second network, discarding one of the control information received from the first network and the control information received from the second network.

### REFERENCE SIGNS LIST

10 in-vehicle network
10A, 10B network
11 Ethernet cable
12 CAN bus
13 coaxial cable
31 communication unit
32 communication unit
33 communication unit
50 processing unit
60 storage unit
100 in-vehicle device
200 relay device
300 in-vehicle communication system
400 vehicle

1.-15. (canceled)

16. An in-vehicle communication system comprising a plurality of in-vehicle devices each being connected to an Ethernet network and a CAN (Controller Area Network), wherein
each of the plurality of in-vehicle devices transmits and receives information to and from another in-vehicle device via the Ethernet network and the CAN, and
at least one of the plurality of in-vehicle devices is able to transmit the same information to the Ethernet network and the CAN in parallel.

17. The in-vehicle communication system according to claim 16, wherein
when the in-vehicle device has detected an abnormality in the Ethernet network, the in-vehicle device switches a part or an entirety of transmission of information via the Ethernet network to transmission of the information via the CAN.

18. The in-vehicle communication system according to claim 17, wherein
when the in-vehicle device has detected an abnormality in the Ethernet network, the in-vehicle device continuously transmits, to the Ethernet network, information, out of the information to be transmitted to the Ethernet network, which is different from the information whose destination has been switched to the CAN.

19. The in-vehicle communication system according to claim 18, wherein
the in-vehicle device determines whether or not the Ethernet network has been restored, and
upon determining that the Ethernet network has been restored, the in-vehicle device restores transmission of the information whose destination has been switched to the CAN, to transmission of the information via the Ethernet network.

20. The in-vehicle communication system according to claim 16, wherein
the in-vehicle device transmits the same information to both the Ethernet network and the CAN, and
when the information received from the Ethernet network overlaps the information received from the CAN, the other in-vehicle device discards one of the information received from the Ethernet network and the information received from the CAN.

21. The in-vehicle communication system according to claim 20, wherein
the in-vehicle device on a transmission side assigns the same sequence number to the pieces of information to be transmitted to the Ethernet network and the CAN in parallel, and transmits the pieces of information, and
the in-vehicle device on a reception side detects an overlap of the pieces of information by using the sequence number included in the received information.

22. The in-vehicle communication system according to claim 16, wherein
the in-vehicle device selectively transmits a part of the information to be transmitted to the Ethernet network, to the Ethernet network and the CAN in parallel.

23. The in-vehicle communication system according to claim 22, wherein
the in-vehicle device transmits information related to control of a vehicle or in-vehicle equipment, out of the information to be transmitted to the Ethernet network, to the Ethernet network and the CAN in parallel.

24. The in-vehicle communication system according to claim 16, wherein
the in-vehicle device transmits information not to be transmitted via the Ethernet network and the CAN, out of the information related to control of the vehicle or the in-vehicle equipment, to the other in-vehicle device via a dedicated line.

25. An in-vehicle communication system comprising a plurality of in-vehicle devices each being connected to a first network and a second network, wherein
each of the plurality of in-vehicle devices transmits and receives information to and from another in-vehicle device via the first network and the second network, and
at least one of the plurality of in-vehicle devices is able to transmit the same information related to control of a vehicle or in-vehicle equipment to the first network and the second network in parallel.

26. An in-vehicle device connected to an Ethernet network and a CAN, comprising:
a processing unit configured to generate information to be transmitted to another in-vehicle device;
a first communication unit configured to transmit the information generated by the processing unit to the other in-vehicle device via the Ethernet network; and
a second communication unit configured to transmit the information generated by the processing unit to the other in-vehicle device via the CAN, wherein
the first communication unit and the second communication unit are able to transmit the same information in parallel.

27. An in-vehicle device connected to an Ethernet network and a CAN, comprising:
a first communication unit configured to receive information from the Ethernet network;
a second communication unit configured to receive information from the CAN; and
a processing unit capable of performing a process using the information received by the first communication unit, and a process using the information received by the second communication unit, wherein
when the information received by the first communication unit overlaps the information received by the second communication unit, the processing unit discards one of the information received by the first communication unit and the information received by the second communication unit.

28. An in-vehicle device connected to a first network and a second network, comprising:
a processing unit configured to generate information to be transmitted to another in-vehicle device;
a first communication unit configured to transmit the information generated by the processing unit to the other in-vehicle device via the first network; and
a second communication unit configured to transmit the information generated by the processing unit to the other in-vehicle device via the second network, wherein
the first communication unit and the second communication unit are able to transmit the same information, in parallel, which is related to control of a vehicle or in-vehicle equipment and is generated by the processing unit.

29. An in-vehicle device connected to a first network and a second network, comprising:
a first communication unit configured to receive information from the first network;
a second communication unit configured to receive information from the second network; and
a processing unit capable of performing a process using the information received by the first communication unit, and a process using the information received by the second communication unit, wherein
when control information that is related to control of a vehicle or in-vehicle equipment and is received by the first communication unit overlaps control information that is related to control of the vehicle or the in-vehicle equipment and is received by the second communication unit, the processing unit discards one of the control information received by the first communication unit and the control information received by the second communication unit.
